(19) United States
(12) Patent Application Publication
(10) Pub. No.: US 2008/0254995 A1
(43) Pub. Date: Oct. 16, 2008

(54) NANOPORE ARRAYS AND SEQUENCING DEVICES AND METHODS THEREOF

(75) Inventors: MinJun Kim, Philadelphia, PA (US); Rafael Mulero, Newark, DE (US); Edward Steager, Wallingford, PA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DREXEL UNIVERSITY, Philadelphia, PA (US)

(21) Appl. No.: 12/036,567

(22) Filed: Feb. 25, 2008

Related U.S. Application Data
(60) Provisional application No. 60/891,759, filed on Feb. 27, 2007.

(51) Int. Cl. C40B 20/04; C40B 60/00; C40B 50/18; B23K 15/00; C40B 30/00

(52) U.S. Cl. 506/4; 506/33; 506/32; 506/7; 219/121.35; 219/121.26

(57) ABSTRACT

Provided are devices comprising one or more nanoscale pores for use in, inter alia, analyzing various biological molecules. Also provided are methods for the fabrication of nanoscale pores in solid-state substrates, methods for functionalizing nanopores in solid-state substrates, and methods for sequencing polymers using devices containing nanoscale pores.

### CROSS-REFERENCE TO RELATED APPLICATIONS

This application claims the benefit of U.S. Provisional Application No. 60/891,759 filed Feb. 27, 2007, the entirety of which is incorporated by reference herein.

### FIELD OF THE INVENTION

The present invention pertains to the field of structures having nanoscale pores. The present invention also pertains to the field of fabrication of nanoscale devices.

### BACKGROUND OF THE INVENTION

Various scientific and patent publications are referred to herein. Each is incorporated by reference in its entirety.

The rapid determination of the nucleotide sequence of single- and double-stranded DNA and RNA is a major goal of researchers seeking to obtain the sequence for the entire genome of an organism. The ability to determine the sequence of nucleic acids in DNA or RNA has additional importance in identifying genetic mutations and polymorphisms.

The concept of using nanometer-sized holes, or “nanopores,” to characterize biological macromolecules and polymer molecules is known in the biological sciences. Several attempts have been made to adapt such nanopores for use in a high-speed method for DNA sequencing. Marziali, A. and Akeson, M., New DNA Sequencing Methods, Ann. Rev. Biomed. Eng. 2001, 3, 195-223.

Nanopore-based analysis methods are typically premised on the concept of passing a molecule, e.g., single-stranded DNA (“ssDNA”), through a nanoscopic opening while monitoring a signal. Li, J., et al., DNA molecules and configurations in a solid-state nanopore microscope, Nature Materials, 2003, 2, 611-615; Akeson, M., Microsecond time-scale discrimination among polycytidylic acid, polyadenylic acid, and polyuridylic acid as homopolymers or as segments within single RNA molecules, Biophys. J., 1999, 77, 3227-3233; U.S. Pat. No. 6,673,615, to Denison, et al.; U.S. Pat. No. 6,015,714, to Baldarelli, et al. Typically, the nanopore is designed to have a size that allows the DNA to pass only in a sequential, single file order. As the ssDNA passes through the nanopore, differences in the chemical and physical properties of the nucleotides that compose the ssDNA are translated into characteristic electrical signals. E.g., U.S. Pat. No. 5,015,714, to Baldarelli, et al.; U.S. Pat. No. 5,795,782, to Church, et al.; U.S. Pat. App. Pub. No. 2006/0063171, by Akeson, et al.

The signal typically detected is modulation of the ionic current by the passage of the DNA through the nanopore, which current is created by an applied voltage across the nanopore-bearing membrane or film. Because of structural differences between different nucleotides, different types of nucleotides interrupt the current in different ways, with each different type of nucleotide within the ssDNA producing a type-specific modulation in the current as it passes through a nanopore. Akeson, M.; et al.

The majority of the work performed in this area pertains to the use of a protein channel in a lipid bilayer. Sauer-Budge, A. F., et al., Phys Rev Let. 2003, 90, 238101-1 to 238101-4. It is known that proteinaceous nanopores, such as those nanpores formed by the toxin protein alpha-hemolysin (“α-HL” or “α-hemolysin” or “alpha-HL”), secreted by the bacterium Staphylococcus aureus, possess a well-defined shape. Means for fabricating such pores are also well-known.

These natural nanopores, however, have certain drawbacks as pertains to characterizing DNA and other macromolecules. Such natural nanopores are mechanically and chemically instable, and, in some cases, are toxic.

In addition, devices using α-hemolysin nanopores to sequence DNA and RNA molecules, have, to date, failed to read the sequence of the molecules at a single-nucleotide resolution; only stretches of tens of bases of the same nucleotide can be distinguished from each other, such as poly adenosine (poly A) from poly cytosine (poly C), and poly A from poly deoxyadenosine (poly dA), by the difference in the ionic current blockade as well as the speed at which the polymer passes the nanopores. Akeson, M., et al.

It is known that in existing techniques, individual nucleotides or base-pairs pass through the nanopore too quickly to allow an accurate determination of the blockage current. Various proposals have been made to circumvent this problem, such as increasing the magnitude of the ion current, Chen, W., et al., Fabrication of 5-7 nm wide etched lines in silicon using 100 keV electron-beam lithography and polymethylmethacrylate resist, Appl. Phys. Lett., 1993, 62, 1499-1501, adding a rotating electric field, Chen C.-M., et al., Appl. Phys. Lett., 2003, 82, 1308-1310, or using a molecular motor capable of moving a target molecule through a nanopore at a specific rate. See U.S. Pat. App. Pub. No. 2006/0063171, by Akeson, et al.

Work has been performed on fabricating and using nanopores in a solid-state thin film. Li, J., et al., Ion-beam sculpting at nanometer length scales, Nature, 2001, 412, 166-169. Nanopores formed in solid-state materials avoid certain of the drawbacks inherent in α-HL nanopores, and because solid-state nanopores are man-made, solid-state pores offer the advantage of controllable pore size. While the fabrication of nanometer-sized pores on solid state materials is possible, reproducibility of the size and shape of the nanopores and reliable control over the size and shape of the nanopores have not been achieved. E.g., Mitsui, et al., Nanoscale Volcanoes: Accretion of Matter at Ion-sculpted Nanopores, Phys. Rev. Lett., 2006, 96, 036102.

Focused ion beam (“FIB”) techniques for forming nanopores have gained some notoriety. E.g., U.S. Pat. No. 7,118,657, to Golovchenko, et al. In 2001, a group reported the invention of an “ion-beam sculpting” technique to fabricate holes with diameters of several nanometers on Si₃N₄ and other solid state films, and demonstrated that these nanopores were capable of detecting individual molecules of 500 base pair double-stranded DNA as the molecules were translocated through a nanopore. Li, J., et al. The limitation, however, presented by fabricating nanopores using FIB is that the minimal feature size accessible by these techniques is typically limited to tens of nanometers, rendering such nanopores unsuitable for sequencing ssDNA, which typically requires nanopore diameters in the range of about 2 nm.

Other etching and lithography techniques for forming nanometer sized-holes in free-standing synthetic, solid-state films have been explored. Ralls, K. S., et al., Fabrication of thin-film metal nanobridges, Appl Phys Lett. 1989. 55, 2459-2461; Apel, P. Y., et al., Diode-like single-ion track membrane prepared by electro-stopping. Nucl. Instrum. Meth., 2001, B184, 337-346 (2001); Siwy, Z., et al., Fabrication of a Synthetic nanopore ion pump, Phys. Rev. Lett., 2002, 89, 198103-1 to 198103-198104. While nanopores produced by these techniques have diameters potentially suitable for application to DNA sequencing, the nanopores were fabricated on comparatively thick films, rendering them unsuitable for studying macromolecules. Experiments investigating the passage of DNA molecules through such solid state nanopores have, however, produced results similar to those obtained using α-hemolysin-based nanopores. Li, J., et al. Thus, rapid DNA sequencing using solid-state nanopores remains impractical.

The need to develop a robust nanopore fabrication technique is underscored by the wide range of uses available for nanopore devices in addition to DNA and RNA sequencing. Nanopores can be used as biosensors to detect other macromolecules, to detect the existence of macromolecular processes, or to detect other biological entities, e.g., bacteria and viruses, based on the unique physical characteristics of the analytes instead of on their biological activities. Prototype biosensors employing genetically engineered α-hemolysin pores have already been devised for the detection of a variety of analytes, including proteins, metal ions, and small organic molecules. Bayley, H. et al., Stochastic sensors inspired by biology, Nature, 2001, 413, 226-30. Others have shown, Desai, T. A., et al., Microfabricated immunoisolating biocapsules, Biotechnol. Bioeng. 1998, 57, 118-120, that cells can be encapsulated within solid-state chambers having nanometer scale holes large enough for small molecules to pass through but also small enough to impede the passage of comparatively large immune system molecules or viruses, thus allowing the enclosed cells to secrete the desired proteins while avoiding attack by viruses or the immune system. Such solid-state capsules can be easily integrated with micro-electronic systems to externally control the drug delivery. Researchers at iMEDD, Inc. describe an implantable drug delivery device based on nanoporous silicon membranes. “Pores Help Nanogate Deliver, MEDICAL MATERIALS UPDATE,” http://www.buscom.com/letters/mmupromo/mmu/mmu.html.

Nanopores can also be used in biofluid purification, specifically for viral elimination of blood products. Burnouf, T., et al., Nanofiltration of plasma-derived biopharmaceutical products, Haemophilia, 2003, 9, 24-37. Additional applications include detecting and counting single molecules, measuring a molecule's length, Kasianowicz, J. J., et al., Characterization of individual polynucleotide molecules using a membrane channel, Proc. Natl. Acad. Sci. USA, 1996, 93: 13770-13773, studying the dynamics of polymer translocation in confined spaces, Meller, A., et al., Voltage-driven DNA translocations through a nanopore. Phys. Rev. Lett., 2001, 86, 3435-3438; 24; Henrickson, S. E., et al., Driven DNA transport into an asymmetric nanometer-scale pore, Phys. Rev. Lett., 2000, 85, 3057-3060, and sensing a polymer's local cross-sectional volume. Akeson, M.; et al.

All of the above mentioned applications of nanopores depend, however, on rapid, reliable fabrication methods for such holes. As described, much effort has been devoted to fabricating pores for use in a wide range of applications. However, these techniques are, to date, incapable of efficiently and reproducibly forming stable nanopores having characteristic cross-sectional dimensions in the single-digit nanometer range. Accordingly, there is a need for a method of fabricating nanopores of single-digit nanometer size in a solid state substrate where the size of the nanopores is controllable and reproducible. Similarly, there is also a related need for devices capable of sequencing molecules having nanoscale dimensions at a high speed and at a high rate of resolution.

### SUMMARY OF THE INVENTION

In overcoming the challenges inherent in reproducibly forming nanoscale pores of controllable size and of characteristics suitable for use in DNA and other biological molecules, the present invention provides, inter alia, a device, comprising: wherein each nanopore comprises a first aperture in the first surface of the substrate, wherein each nanopore further comprises a second aperture in the second surface of the substrate, wherein each nanopore further comprises a cavity in the solid state substrate, and wherein the cavity places the first aperture of the nanopore in fluid communication with the second aperture of the nanopore.

In another aspect, the present invention provides a method, comprising: (a) directing an electron beam of a scanning transmission electron microscope towards a target location on a first surface of a solid-state substrate; (b) adjusting the electron beam so as to give rise to a cavity originating at the target location and extending at least partway into the solid state substrate, wherein the solid-state substrate comprises a first surface and a second surface, wherein the operating parameters of the electron beam comprise at least an intensity and an accelerating voltage; (c) terminating the electron beam; (d) inspecting the target location; and (e) iteratively performing steps (a), (b), (c), and (d), so as to give rise to at least 100 template pores of desired characteristic cross-sectional dimension, wherein the template pores are capable of placing the first surface and second surface of the solid state substrate in fluid communication with one another.

Further provided is a method, comprising: ablating material from a first surface of a solid-state substrate so as to give rise to a cavity formed within the first surface, the cavity comprising a bottom contiguous with the first surface; and forming at least 100 nanopores extending between the bottom surface of the cavity and a second surface of the substrate.

In another aspect is a method, comprising: adapting at least 100 nanopore openings in a solid-state substrate such that the adapted openings are capable of conjugating a lipid entity; and conjugating a lipid entity to the adapted nanopore openings.

Additionally provided is a method, comprising: modifying at least a portion of an inner surface of at least 100 solid-state nanopores; and conjugating a charge-shielding agent to at least a portion of the modified portion of the inner surface of the solid-state nanopores.

The present invention further provides a method, comprising: inducing linear passage of at least a portion of a molecule through at least a portion of 100 or more nanopores, wherein each nanopore comprises at least one inner surface, wherein each nanopore has a characteristic cross-sectional dimension in the range of from about 0.5 nm to about 50 nm, and wherein a charge-shielding agent is present on at least a portion of at least one inner surface of the nanopore; detecting one or more signals arising from the passage of the molecule through the one or more nanopores; and analyzing the one or more signals.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 depicts the fabrication steps involved in nanopore array preparation: (1) definition of a 50 nm Si₃N₄ membrane window; (2) deposition of 200 nm thick SiO₂ and 500 nm thick Si₃N₄ layers using plasma-enhanced chemical vapor deposition (PECVD); (3) fabrication of a 2 micron diameter well array using a FIB in the Si₃N₄ layer; (4) removal of the SiO₂ layer; and (5) nanopore drilling in each well using a TEM;

FIG. 2 depicts an illustration of a phospholipid conjugating to the positively-charged surface of a solid-state substrate;

FIG. 3 depicts TEM images of a giant vesicle deposited on a Si₃N₄ substrate, FIG. 3(a) depicts a 100 nm pore deposited by a giant vesicle; FIGS. 3(b) and 3(c) depict a magnified portion of the pore following vesicle fusion;

FIG. 4 depicts an illustration of a α-HL protein forming a pore in a lipid species conjugated to a solid-state substrate; FIG. 4(a) depicts an array of nanopores in a solid-state substrate; FIG. 4(b) depicts a lipid species conjugated to a solid-state substrate; FIG. 4(c) depicts α-HL proteins in proximity to the lipid species; and FIG. 4(d) depicts an α-HL protein channel formed in the lipid species;

FIG. 5 depicts (left panel) a limiting construction of the α-HL pore, and (right panel) a chemically-modified nanopore, emphasizing control over the pore diameter, d, and surface functionality;

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a, ” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

In one aspect, the present invention provides a device, comprising a solid-state substrate comprising a first surface, a second surface, and at least 100 nanopores, Each nanopore is functionalized with a charge-shielding agent. Each nanopore comprises a first aperture in the first surface of the substrate, and each nanopore suitably further comprises a second aperture in the second surface of the substrate.

A nanopore further comprises a cavity in the solid state substrate, wherein the cavity places the first aperture of the nanopore in fluid communication with the second aperture of the nanopore.

The substrate can be in the range of from about 20 nm to about 200 nm in thickness, and can be in the range of from about 30 nm to about 50 nm in thickness.

Substrates comprise one or more materials capable of being shaped or formed. Suitable materials include ceramic, alloys, metals glass, quartz, silicon, alumina, tungsten, titanium, or any combination thereof. Si₃N₄, and SiO₂, are considered particularly suitable substrates. Substrates suitable for use in the present invention may be purchased, e.g., Protochips, Inc. (www.protochips.com), or prepared. The preparation of such substrates is known to those practicing in the field.

The cross-section of the nanopore cavity can, in some embodiments, be characterized as circular in cross section. In other configurations, the cross-sectional area of the nanopore cavity can be characterized as being a regular or irregular polygon having from 2 to 12 sides.

A charge shielding agent includes one or more entities capable of reducing electrical interactions between the inner surface of the nanopores and any entity present within the nanopores, capable of reducing electrical noise present in one or more electrical connections comprising the nanopore, or any combination thereof. Suitable charge-shielding agents include self-assembling organosilanes, proteinaceous agents, and bifunctional surfactants, or any combination thereof. Suitable organosilanes include glycidyloxypropyltrimethoxysilane, methoxyethoxy-undecyltrichlorosilane, aminopropyl-trimethoxysilane, 15-hexadecenyltrichlorosilane, octadecyltrichlorosilane, and the like, or any combination thereof. Such agents are commercially available from Alfa-Aesar (www.alfa.com), Sigma-Aldrich (www.sigmaaldrich.com), and other vendors. Suitable proteinaceous agents include alpha-hemolysin, B. anthracis protective antigen 63 (PA₆₃), or any combination thereof. These proteinaceous agents are available from commercial suppliers, such as Sigma-Aldrich.

Suitable bifunctional surfactants include one or more sulfates of a propoxylated, ethoxylated tridecyl alcohol, available from, e.g., Stepan, Inc. (www.stepan.com).

Each nanopore can have a characteristic cross-sectional dimension in the range of from about 0.5 nm to about 20 nm, or in the range of from about 2 to about 15 nm, or even in the range of from about 5 to about 10 nm. Without being bound to any particular limitations or theories, it is expected that nanopore apertures in the range of from about 2 to about 6 nm are suitable for single- or double-stranded DNA analysis and in the range of from about 5 to about 20 nm for protein analysis. The nanopores are suitably separated from one another by at least 5 micrometers. In embodiments where the device is to be used for molecule analysis, the device is capable of being connected to a monitor, wherein the monitor is capable of recording electric signals from the device related to the passage of at least part of a molecule through at least part of a nanopore. Such monitors include computers, voltmeters, and other data analysis devices.

In another aspect, the present invention provides a method, comprising: (a) directing an electron beam of a scanning transmission electron microscope towards a target location on a first surface of a solid-state substrate; (b) adjusting the electron beam so as to give rise to a cavity originating at the target location and extending at least partway into the solid state substrate, wherein the solid-state substrate comprises a first surface and a second surface, wherein the operating parameters of the electron beam comprise at least an intensity and an accelerating voltage; (c) terminating the electron beam; (d) inspecting the target location; and (e) iteratively performing steps (a), (b), (c), and (d), so as to give rise to at least 100 template pores of desired characteristic cross-sectional dimension, wherein the template pores are capable of placing the first surface and second surface of the solid state substrate in fluid communication with one another.

The electron beam can have an intensity in the range of about 10⁷ e/nm² to about 10¹¹ e/nm², or in the range of from about 10⁸-10⁹ e/nm². The accelerating voltage of the electron beam can be in the range of from about 150 keV to about 300 keV, or even in the range of from about 200 keV to about 250 keV. Microscopes suitable for use are commercially available, such as TEM instruments, and include the JEOL 2010F (wwwjeol.com).

The scanning transmission electron microscopes include a condenser stigmator. Operating parameters of the TEM are adjusted, which includes adjusting the condenser stigmator so as to give rise to an electron beam pattern on the solid state substrate capable of ablating material from the solid state substrate. In some embodiments, adjusting the stigmator comprises fully converging the condenser stigmator to cross-over then over-focusing the condenser stigmator to give rise to a point of high intensity surrounded by a locus characterized as being in the form of a halo. The point and halo have intensities in the range of from about 10⁸ to about 10⁹ e/nm² and in the range of from about 10⁴ to about 10⁵ e/nm², respectively.

Inspecting the target location can include optically inspecting the target location, which may be accomplished by microscopy methods known to those of ordinary skill in the art. Inspecting the target location can also include inspecting the target location with an electron microscope, the use of which will be known to those familiar with the field. Inspection by electron microscope can include using an α-selector and spot size setting of 3 and 1, respectively, on the JEOL instrument, to improve electron beam coherence. Inspection can also comprise activating a wobbler so as to optimize the focus of the electron beam on the substrate surface, viewing a live fast Fourier transform of the substrate, or any combination thereof. Viewing a live fast Fourier transform of the substrate can be accomplished by using the Digital Micrograph™ software. Inspecting the target location can also include measuring the transmission rate of electrons, ions, or any combination thereof, at the target location.

It is contemplated that the template pore suitably has a characteristic cross-sectional dimension in the range of from about 5 nm to about 10 nm.

Methods further include forming one or more additional template pores of the desired characteristic cross-sectional dimension in the solid state substrate, wherein forming the additional pores comprises utilizing the operating parameters of the electron beam used to form the template pore. In addition to beam intensity and accelerating voltage, operating parameters can also include dwell time, electron energy loss spectra, or any combination thereof. By utilizing the electron beam operating parameters used to produce the first template pore, the methods enable rapid formation of additional pores on the same or different substrates.

Methods include directing the electron beam of the scanning transmission electroscope to one or more additional locations on a surface of the solid state substrate, wherein the operating parameters of the electron beam directed to the additional locations are those operating parameters used in forming the template pore. A scanning transmission electron microscope control system. Suitable control systems include the Nano Pattern Generation System (NPGS; wwwjcnabity.com).

The template pores are suitable separated from one another by at least 500 micrometers. The solid-state substrate suitably has an area of at least 500 square micrometers.

It is contemplated that the methods further comprise altering the characteristic cross-sectional dimension of the template pore by using the electron beam to sputter solid-state substrate material proximate to the template pore so as to shrink the characteristic cross-sectional dimension of the template pore to give rise to a final pore of the desired size.

Suitably shrinking a pore includes the steps of: (g) directing the electron beam of the scanning transmission electron microscope at or proximate to the template pore, (h) adjusting the operating parameters of the electron beam so as to give rise to an electron beam capable of sputtering solid state substrate material so as to reduce the characteristic cross-sectional dimension of the pore, wherein the operating parameters comprise an intensity and an accelerating voltage; (i) terminating the electron beam; (j) inspecting the pore; (k) iteratively performing steps (g), (h), (i), and (j) so as to give rise to a final pore of desired characteristic cross-sectional dimension, wherein the pore places the first surface and second surface of the solid state substrate in fluid communication with one another.

The electron beam comprises an intensity in the range of from about 10⁴ e/nm² to about 10⁸ e/nm², and an accelerating voltage in the range of from about 150 keV to about 300 keV. Suitable methods for adjusting the operating parameters of the beam are described elsewhere herein, as are methods for inspecting the template pore.

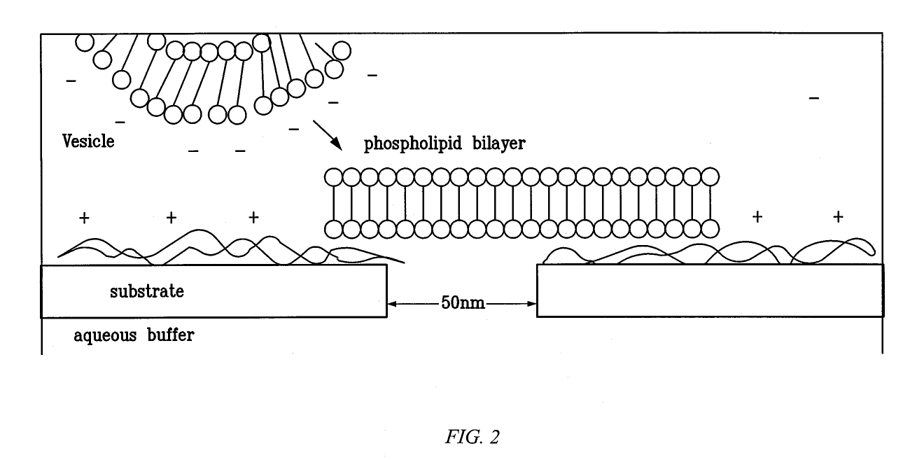

FIG. 2 depicts the three stages of nanopore formation by the instant method. Region I depicts initial pore formation and rapid pore widening, Region II depicts the controlled expansion or contraction of the nanopore, both of which are dependent on electron beam intensity. A n electron beam having an intensity in the range of about 10⁸ e/nm² gives rise to pore expansion, while an electron beam having an intensity in the range of about 10⁶ e/nm² gives rise to pore contraction.

A final nanopore can have a characteristic cross-sectional dimension in the range of from about 0.5 nm to about 20 nm, from about 5 nm to about 15 nm, or from about 8 to about 12 nm. Nanopore characteristic cross-sectional dimensions suitable for particular applications are described elsewhere herein.

The methods of the present invention can include forming one or more additional final pores. The forming comprises utilizing the operating parameters of the electron beam used to form the first final pore. Operating parameters are described elsewhere herein.

The electron beam of the scanning transmission electroscope is directed proximate to one or more additional template pores on a surface of the solid state substrate, wherein the operating parameters of the electron beam are capable of forming the final pore. The methods can entail the use of a scanning transmission electron microscope control system, which, in some configurations, permits fully automated fabrication of the nanopores.

Solid-state substrates suitable for the method include glass, quartz, silicon, alumina, tungsten, titanium, ceramic, polymers, alloys, metals, or any combination thereof, Si₃N₄ or SiO₂ are considered particularly suitable. Substrates suitably have a thickness in the range of from about 20 nm to about 400 nm, of from about 50 nm to about 200 nm, or even about 80 nm to about 100 nm.

The present invention also contemplates devices made according to the methods described herein, and, in certain embodiments, the devices may be used as sequencers, probes, sensors, filters, or any combination thereof.

In another aspect, the present invention provides methods comprising ablating material from a first surface of a solid-state substrate so as to give rise to a plurality of cavities formed within the first surface, the cavities comprising a bottom contiguous with the first surface; and forming at least 100 nanopores extending between the bottom surface of the cavities and a second surface of the substrate.

It is contemplated that the solid-state substrate comprises one or more layers, wherein the layers reside parallel to one another. Suitable substrates can be made by those practicing in the art or purchased commercially. E.g., Protochips, Inc. (www.protochips.com).

Suitable substrates comprise a primary layer having a first surface and a second surface, wherein the primary layer has a thickness in the range of from about 5 nm to about 1000 nm, and can be in the range of from about 300 to 500 nm.

The primary layer can comprise ceramic, alloys, metals, glass, quartz, silicon, alumina, tungsten, titanium, or any combination thereof. Si₃N₄ is considered particularly suitable for use in the primary layer.

The substrate can include a secondary layer comprising a first and a second surface, and wherein the second surface of the primary layer surmounts the first surface of the secondary layer. The secondary layer has a thickness in the range of from about 20 nm to about 500 nm, or in the range of from about 30 to about 80 nm in thickness. Materials suitable for use in the second layer include glass, quartz, silicon, alumina, tungsten, titanium, ceramic, alloys, metals, or any combination thereof. In certain embodiments, the secondary layer comprises SiO₂.

Substrates further include a tertiary layer comprising a first and a second surface, and wherein the second surface of the secondary layer surmounts the first surface of the tertiary layer. The tertiary layer has a thickness in the range of from about 20 nm to about 200 nm, or in the range of from about 80 nm to about 100 nm. Materials suitable for use in the tertiary layer include ceramic, alloys, metals glass, quartz, silicon, alumina, tungsten, titanium, or any combination thereof. Si₃N₄ is a particularly suitable material for the tertiary layer.

Material can be ablated from the primary layer using ion beam drilling, exposure to electron beam, chemical etching, photolithography, microfabrication, pulling, or any combination thereof The bottom surface of a cavity formed by the ablating comprises at least a portion of the first surface of the secondary layer residing proximate to the primary layer.

The method further comprises ablating material from the secondary layer such that the bottom surface of a cavity comprises at least a portion of the first surface of the tertiary layer residing proximate to the secondary layer. The secondary layer is ablated by ion beam drilling, exposure to electron beam, chemical etching, photolithography, microfabrication, pulling, or any combination thereof.

Cavities formed by the methods are contemplated as having a characteristic characteristic cross-sectional dimension in the range of from about 500 nm to about 5000 nm, from about 1000 nm to about 3000 nm, or from about 1500 nm to about 2000 nm. Cavities may have cross-sectional areas characterized as circular, or, in some embodiments, cross-sectional areas characterized as a polygon having from 2 to 12 sides.

Forming the nanopore can include removing material from the bottom surface of the cavity to give rise to an aperture at the bottom surface of a cavity, wherein the aperture places the first and second surfaces of the solid-state substrate in fluid communication with each other. The removing can be accomplished by ion beam drilling, exposure to electron beam, chemical etching, photolithography, microfabrication, pulling, or any combination thereof.

Apertures may have cross-sectional areas characterized as circular or, in some configurations, characterized as a polygon having from 2 to 12 sides. Suitable apertures can have a characteristic cross-sectional dimension in the range of from about 0.5 nm to about 20 nm, of from about 2 to about 10 nm, or from about 5 to about 8 nm.

The nanopores formed by the described methods are suitably separated by at least 5 micrometers. Substrates suitable for the method have surface areas of at least 500 square micrometers.

Nanopores formed by the methods described herein include a lumen having a length of about the thickness of the tertiary layer of the solid-state substrate.

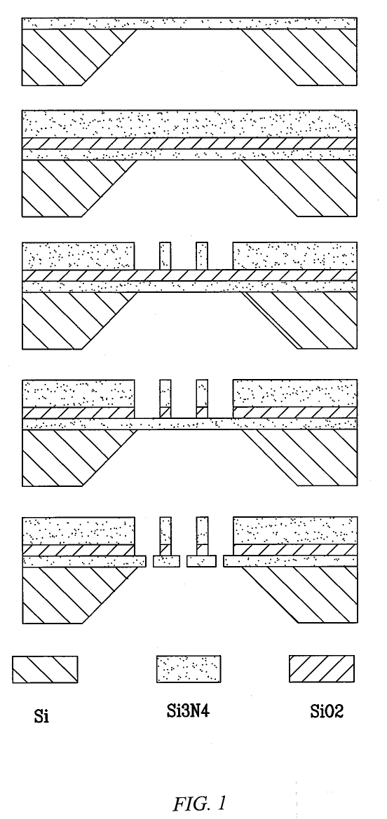

One embodiment of the method is exemplified in FIG. 1. FIG. 1 depicts a multi-layered substrate envisioned in the invention, showing (1) definition of a 50 nm Si₃N₄ membrane window; (2) deposition of 200 nm thick SiO₂ and 500 nm thick Si₃N₄ layers using plasma-enhanced chemical vapor deposition; (3) fabrication of a 2 micron diameter well array using a FIB in the Si₃N₄ layer; (4) removal of the SiO₂ layer; and (5) nanopore drilling.

The present invention also includes devices made according to the instant method. It is contemplated that such a device is suitable for use as a probe, a sensor, a sequencer, a filter, or any combination thereof.

In another aspect, the present invention provides a method, comprising: adapting at least 100 nanopore openings in a solid-state substrate such that the adapted openings are capable of conjugating a lipid entity; and conjugating a lipid entity to the adapted nanopore openings.

A schematic of this aspect of the invention is shown in FIG. 2 which depicts a negatively-charged lipid species (a phospholipid bilayer) conjugating to a positively-charged solid state substrate. In some cases, such as the situation depicted in FIG. 2, the lipid species is capable of covering at least a portion of a nanopore formed in the solid-state substrate.

Suitable solid-state substrates are described elsewhere herein.

It is envisioned that adapting a nanopore opening comprises contacting the solid-state substrate with an agent capable of giving rise to a positive charge on the surface of the substrate. Suitable agents include amine-modified silanes, and, in some embodiments, can include poly-D-lysine hydrobromide, poly-L-lysine hydrobromide, poly-L-lysine, poly-L-ornithine hydrobromide, or any combination thereof.

A lipid entity suitable for the methods includes a unilamellar lipid vesicle, a giant unilamellar vesicle, a bilayer lipid vesicle, a lipid layer, a lipid bilayer, or any combination thereof. Such entities are readily made by those of ordinary skill in the art; materials for such lipids are available from Avanti, Inc. (www.avantilipids.com). Conjugating the lipid entity to a nanopore opening comprises contacting the lipid entity to a nanopore, to the substrate proximate to a nanopore, or any combination thereof. The conjugating can, in certain configurations, comprise positioning the lipid entity relative to a nanopore using a directed electric field, prior to contacting the lipid entity to an adapted nanopore.

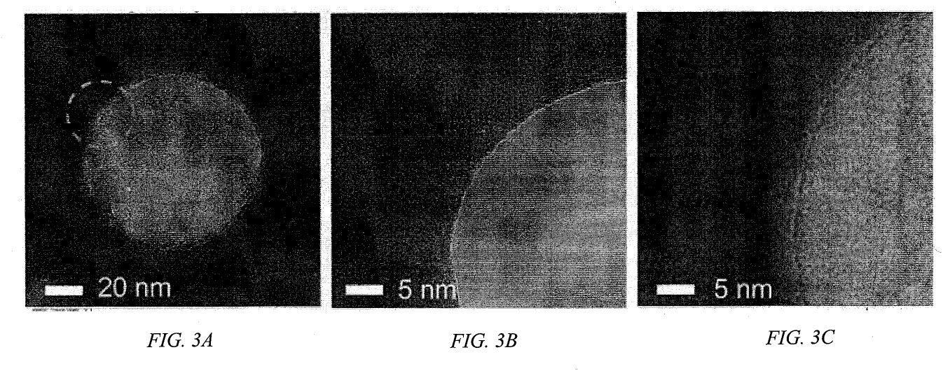

FIG. 3 is a TEM image of a giant vesicle deposited on a Si₃N₄ substrate. In FIG. 3, a 100 nm nanopore (FIG. 3(a)) is seen before (FIG. 3(b)) and after (FIG. 3(c)) vesicle conjugation.

The method further includes contacting a channel-forming agent to the conjugated lipid entity, under conditions capable of giving rise to a channel extending through the lipid entity, and, in some embodiments, into a nanopore. Suitable channel-forming agents include alpha-hemolysin, B. anthracis protective antigen 63 (PA₆₃), or any combination thereof

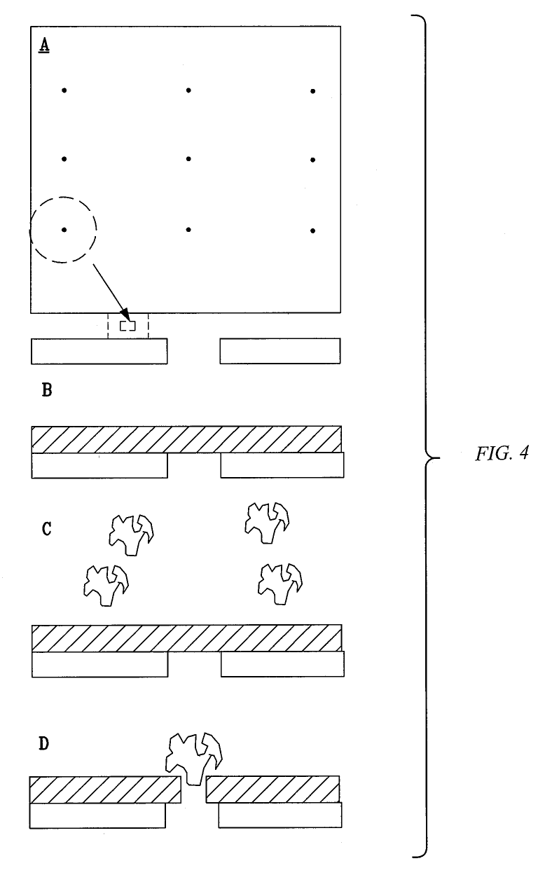

A schematic representation of alpha-hemolysin forming a channel in a lipid species conjugated to a solid-state substrate is shown in FIG. 4 . FIG. 4(a) depicts an array of nanopores in a solid-state substrate. FIG. 4(b) depicts a lipid species that has been conjugated to the substrate. FIG. 4(c) depicts several α-HL proteins in proximity to the lipid species, which, may, in some cases, be accomplished by contacting a solution containing alpha-hemolysin to the lipid species, and FIG. 4(d) depicts an α-HL protein channel formed in the lipid species;

Nanopores formed by the method are suitably separated from one another by at least 5 micrometers. Solid state substrates suitable for the method are at least 500 square micrometers in area.

The present invention also includes devices made according to the instant method. Such device are useful as a probe, a sensor, a sequencer, a filter, or any combination thereof.

In a further aspect, the present invention provides methods, comprising: modifying at least a portion of an inner surface of at least 100 solid-state nanopores; and conjugating a charge-shielding agent to at least a portion of the modified portion of the inner surface of the solid-state nanopores.

The modifying comprises contacting at least a portion of an inner surface of a solid-state nanopore with an agent, wherein the agent is capable of giving rise to at least one anchoring group on the inner surface of the solid-state nanopores. Suitable agents include piranha solution, RCA solution, or any combination thereof. Piranha solution comprises 4:7 30% H₂O₂/98% H₂SO₄, and RCA solution comprises 1:1:5 27% NaOH/30% H₂O₂/ DI H₂O.

The anchoring group can be capable of conjugating to a charge-shielding agent; suitable anchoring groups comprise silicon, silicon nitride, silanol, or any combination thereof. Suitable charge-shielding agents are described elsewhere herein. In some configurations, charge-shielding agents can comprise entities having tunable end groups.

Conjugating a charge shielding agent to a modified portion of the substrate comprises contacting the charge-shielding agent to the modified inner surface of the nanopore.

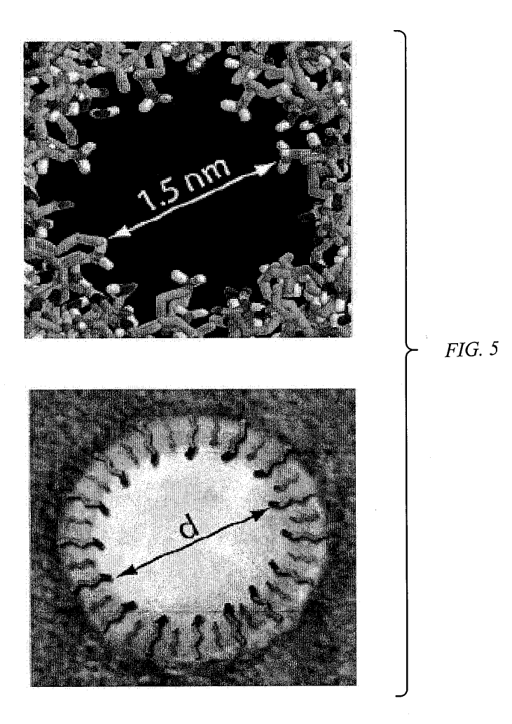

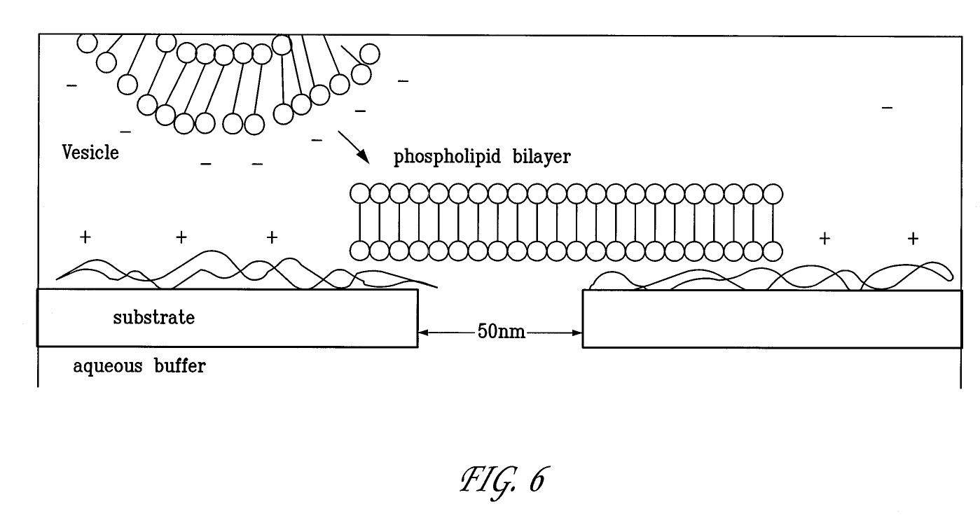

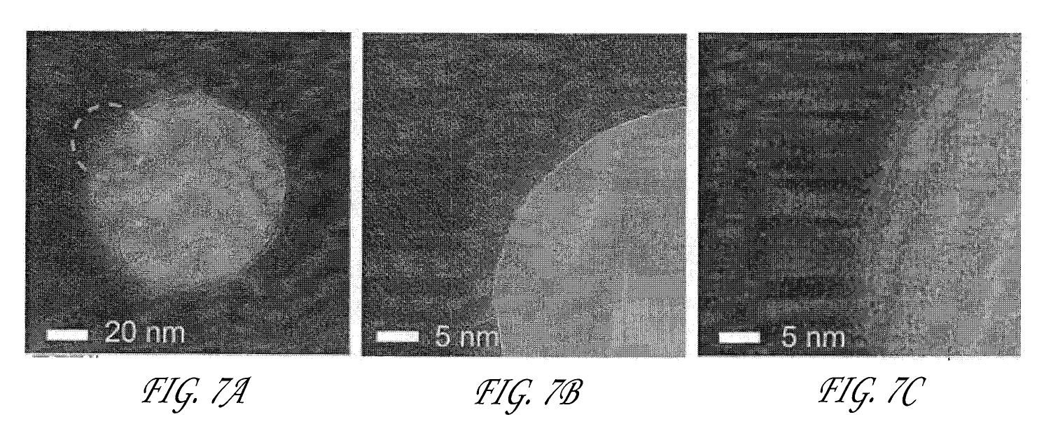

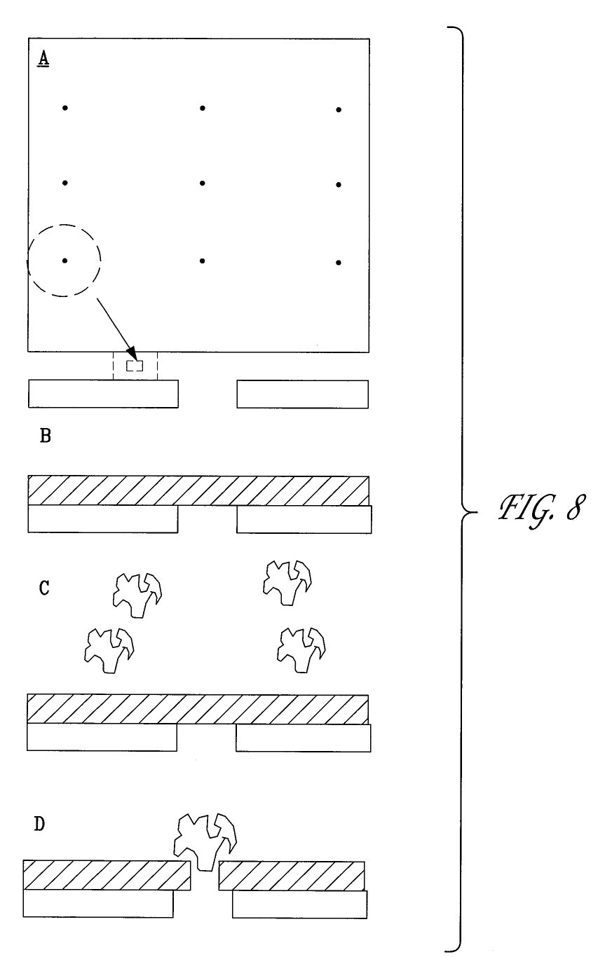

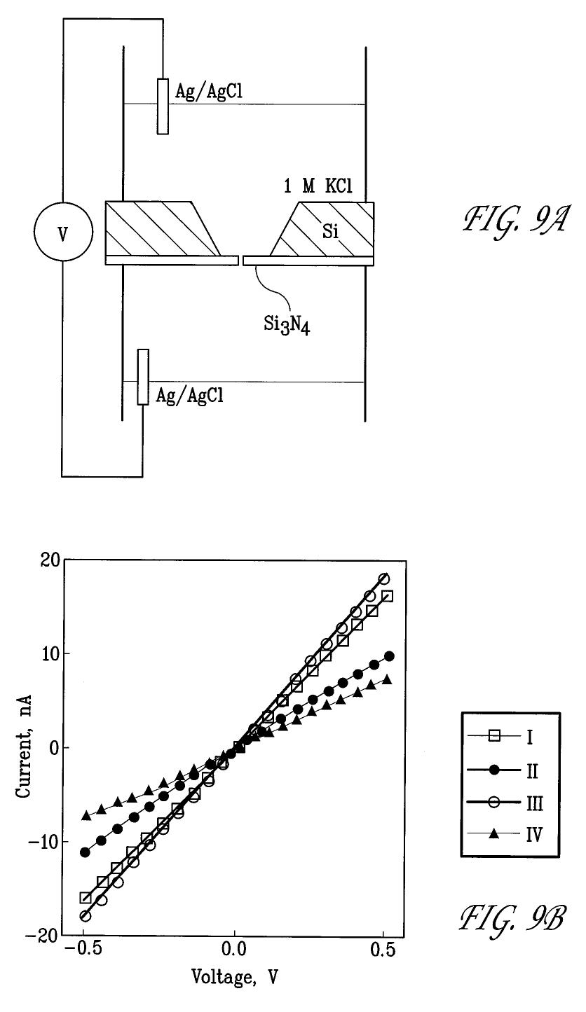

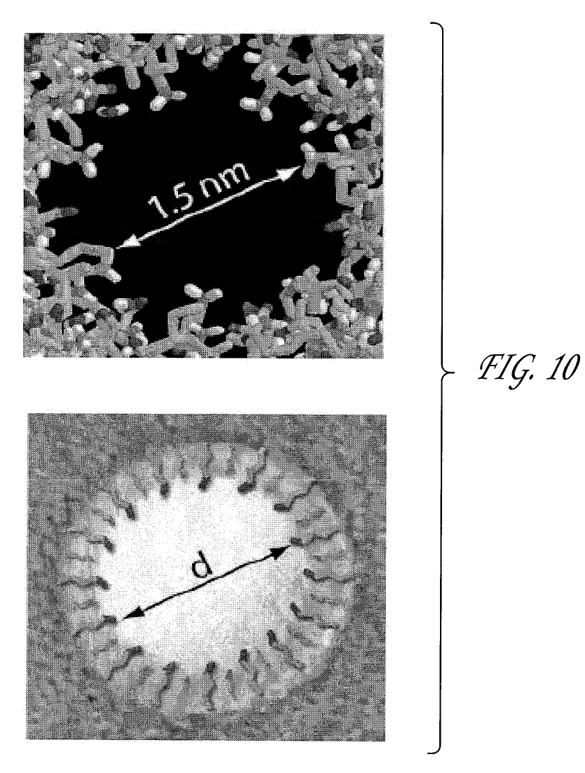

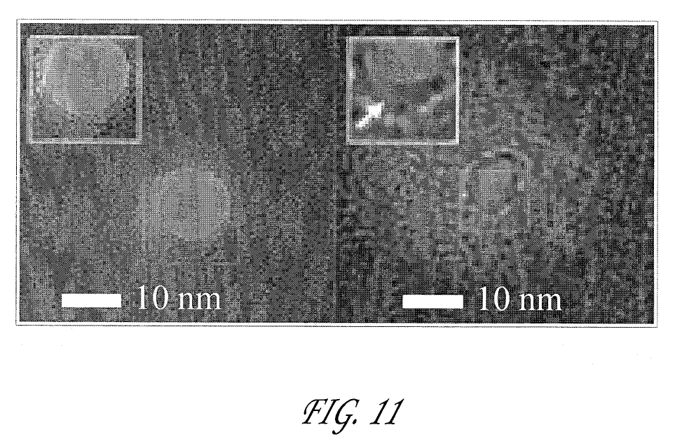

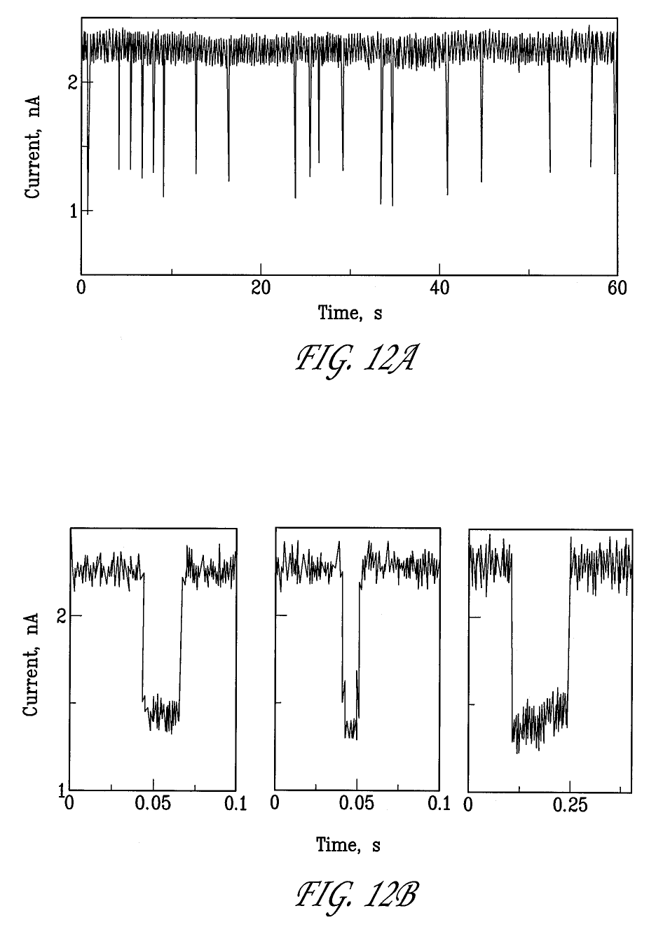

FIG. 5 depicts, in drawing format, the presence of charge-shielding agents on the inner surface of the nanopore. Without being bound to any particular mode of operation, it is believed that the presence of the charge-shielding agent on the inner surface of the nanopore is capable of reducing the effective diameter of the pore.

Suitable organosilanes comprise glycidyloxypropyltrimethoxysilane, methoxyethoxy-undecyltrichlorosilane, aminopropyl-trimethoxysilane, 15-hexadecenyltrichlorosilane, octadecyltrichlorosilane, or any combination thereof. Bifunctional surfactants contemplated as being suitable for the method comprise one or more sulfates of a propoxylated, ethoxylated tridecyl alcohol.

The nanopores are suitably separated from one another by at least 5 micrometers.

The present invention also provides devices made according to the methods described herein. Such devices are suitable for use as sensors, probes, filters, and the like.

In another aspect, the present invention provides methods, comprising: inducing linear passage of at least a portion of a molecule through at least a portion of at least 100 nanopores, wherein each nanopore comprises at least one inner surface, wherein each nanopore has a characteristic cross-sectional dimension in the range of from about 0.5 nm to about 50 nm, and wherein a charge-shielding agent is present on at least a portion of at least one inner surface of the nanopore; detecting one or more signals arising from the passage of the molecule through the one or more nanopores; and analyzing the one or more signals.

Characteristic cross-sectional dimensions of nanopores suitable for various applications are described elsewhere herein.

The nanopores are suitably formed in a solid state substrate. Suitable substrate materials include ceramic, alloys, metals glass, quartz, silicon, alumina, tungsten, titanium, or any combination thereof Suitable substrates have a surface area of at least 500 square micrometers.

Suitable charge-shielding agents are described elsewhere herein, and can include alpha-hemolysin, B. anthracis protective antigen 63 (PA₆₃), or any combination thereof

These methods include inducing linear passage of at least a portion of a polymer through at least a portion of one or more nanopores comprises translocating at least a portion of the polymer through at least a portion of at least one nanopore mechanically, chemically, electrochemically, electrically, optoelectronically, osmotically, acoustically, magnetically, or any combination thereof.

Suitable signals that are analyzed include an electrical signal, an optical signal, a mechanical signal, a radioactive signal, a magnetic signal, an acoustic signal, or any combination thereof.

Analyzing the signal can include recording the signal, comparing the signal to a signal known to correspond to the passage through the nanopore of a monomer, comparing the signal to other recorded or real time signals, transmitting the signal, performing mathematical operations on the signal, or any combination thereof.

The present invention also includes devices made according to the instant method. Such devices are used for analyzing polymers, biological molecules, or any combination thereof.

### EXAMPLES

The following are non-limiting examples that are representative only and that do not necessarily restrict the scope of the present invention.

### Example 1

Solid-state nanopores were fabricated; all fabrications started with formation of a 50 nm thick DuraSiN™ silicon nitride membrane (Protochips Inc, Raleigh, N.C.). Solid-state nanopores were directly drilled by a JEOL 2010F field emission TEM.

Alignment of the electron probe involved condenser stigmation to the familiar triangle shaped beam, using a large condenser aperture; the probe seen is dominated by three-fold aberrations. The condenser lens was fully converged to crossover then slightly over focused. The resultant beam was an intense point with a triangular halo of low intensity. The remainder of the column alignment followed from normal high resolution transmission electron microscopy (“HRTEM”) alignment procedures. After the alignment of the electron probe, nanopores with characteristic cross-sectional dimensions in a range of 3-6 nm were directly drilled by an electron beam intensity of about 2.5×10⁸ e/nm²s using a magnification of 800 K. The time for pore formation in the 50 nm thick Si₃N₄ membrane was less than 40 seconds for a 200 keV beam.

The shrinking and expanding process was controlled by manipulating the intensity of the electron beam until the desired characteristic cross-sectional dimension was reached. In order to fabricate nanopores having a characteristic cross-sectional dimension in the range of from about 10 to about 20 nanometers, a 5 nm characteristic cross-sectional dimension nanopore was further expanded by an electron beam intensity of about 0.5×10⁷ e/nm²s using a magnification of 500 K. The time for growing nanopores from 5 nm to 20 nm was less than 5 minutes. Single nanometer scale fabrication with TEM led to fine-tuning the shapes of nanopores as well, which resulted in the nanopores shown in FIG. 3.

### Example 2

A two-layer structure, 200 nm of SiO₂ and 500 nm thick capping layer of Si₃N₄, was formed by plasma enhanced chemical vapor deposition (PECVD). A focused ion beam (FIB) drilled a 2 micrometer characteristic cross-sectional dimension well array in the first 500 nm thick silicon nitride layer. After this process, the silicon dioxide layer was removed by buffered oxide etch (BOE), to a 50 nm thick silicon nitride membrane for single nanometer scale pores.

An array of low-density nanopores (2×2, 3×3, and 6×6) was integrated into a monolithic silicon-based chip using scanning transmission electron microscope (STEM). The arrays were formed by patterning beam scanning without well arrays. Automated patterning of nanopores was accomplished by operating the microscope in STEM mode and directly addressing the scan coils to deflect the beam by the desired amount. This method was enabled by direct beam control through either an analytical x-ray acquisition system or dedicated electron beam lithography system, such as the Nanopattern Generation System (“NPGS”), modified for use on the STEM system. In such a system the probe shift has been calibrated for x-y translation and electron beam dwell times were specified for various points on the sample, with such a system it was possible to produce as many points as designed on the substrate.

### Example 3

FIG. 5 illustrates a comparison between the proteinaceous α-HL nanopore and a drawing of a chemically modified solid-state nanopore. In principle, both the thickness of the coating and the terminal group can be controlled, rendering this approach highly versatile. The coated nanopores are directly imaged.

Nanopores were characterized using ellipsometry, atomic force microscopy (AFM), and X-ray photoelectron spectroscopy (XPS) on model substrates, consisting of 50-nm-thick Si₃N₄ films evaporated by LPCVD on Si wafers.

Following drilling of the nanopores by TEM, the chips were placed in a 10×75 mm test tube and about 3 ml fresh solution of boiling piranha was added (4:7 30% H₂O₂: 98% H₂SO₄). The beaker was heated to sustain boiling for 15 min, after which the piranha solution was removed and the chip was thoroughly rinsed with Millipore water, methanol, and dried using N₂ stream. The chips remained hydrophilic in ambient air for less than about 10 minutes.

Three types of organosilanes were applied for the proposed method of coating the inner surfaces of nanopores. Coatings 1 and 2 were formed by a monolayer self-assembly step. Coating 3 was generated sequentially in three steps, starting with an amino-terminated monolayer.

Coating 1. Following piranha and water rinse steps, the chip was dried under N₂ and placed on a hotplate set to 100° C. for 10 min. The chip was cooled under N₂ and placed in a 0.1% solution of glycidyloxypropyltrimethoxysilane (Alfa-Aesar, 97%) in anhydrous toluene (Burdick & Jackson, further dried under CaH₂) for 1 h. The chip was frequently agitated during the assembly process. The chip was then immersed and agitated in fresh toluene (8×3 ml) for 10 min, dried under N₂ and heated to 100° C. for 1 h.

Coating 2. Following the piranha and water rinse steps, the chip was dried under N2 and placed (membrane side up) on a hotplate set to 100° C. for 10 min. The chip was then immediately transferred under N₂ to a 2 mM solution of methoxyethoxy-undecyltrichlorosilane (Gelest) in anhydrous toluene for 20 min. The chip was then immersed and agitated in fresh toluene (8×3 ml) for 10 min, washed with methanol, and washed copiously with water and dried under N₂.

Coating 3. Following the piranha and water rinse steps, the coating was applied in three steps: (a) The chip was rinsed thoroughly with methanol and placed in a 10% solution of aminopropyl-trimethoxysilane (Acros) in anhydrous methanol for 3-6 hours. The chip was then rinsed thoroughly with methanol (8×3 ml) under agitation for 10-15 min, dried under N₂, and heated at 100° C. for 30 min. (b) The chip was then immersed in a 5% solution of adipoyl chloride (Alfa-Aesar, 97+%) in anhydrous toluene for 30 min. The solution was then removed to near dryness under nitrogen and fresh toluene was added; this process was repeated 8 times while agitating the test tube, followed by drying under N₂. (c) The chip was immersed in a 1% solution of diaminobutane in 1:1 chloroform:acetonitrile (both solvents were anhydrous, Baker) for 2 hours, rinsed with methanol (8×3 ml), water, and dried under nitrogen.

### Example 4

Solid-state nanopores were fabricated by TEM and FIB. Fabrication began with formation of a Si₃N₄ membrane deposited across a 350 micron thick silicon wafer, starting with a 50 nm thick membrane. A 50 micron×50 micron window was then fabricated in the wafer using photolithography and standard wet-etching. Nanopore fabrication was then performed in the thin Si₃N₄ membrane using a JEOL 2010F field emission TEM and a FEI Strata DB 235 FIB. Pores with radii in the range of from about 0.5 to about 10 nm were directly drilled with the electron beam of the TEM. The time for pore formation could vary depending on the intensity of the electron beam, ranging from 30 seconds to 2 minutes for a 200 keV beam at about 2.5×10⁸ e/nm²s. In order to obtain bigger pores (in the range of from about 50 to about 500 nm), a 30 keV Ga+ focused beam with a beam current of 30 pA was used to etch through the membrane. Both methods for producing solid-state nanopores provide visual feedback over the formation process and allow fabricating desired sizes controllably.

### Example 5

By monitoring the conductance of a voltage biased pore, translocation of λ-DNA at 500 mV applied potential across a 6 nm solid-state pore were detected. The event time for each translocation varied, as well as the current fluctuations. Each nanopore chip was mounted in a custom-built cell to enable low-noise electrical and optical measurements. This cell forms miniature “cis” and “trans” fluid chambers, accessible by fluid lines. The two chambers were fitted with ports for Ag/AgCl electrodes connected to an Axopatch 200B headstage. Signals were low-pass filtered at 20 KHz using a Butterworth filter and digitized at 100 KHz (12 bit). Figure xx displays ion current blockades produced by applying λ-DNA ([λ-DNA] of about 1 mg/ml) to the negative chamber of a chip (the “cis” chamber) containing a single 6 nm nanopore.

Upon the addition of the DNA, the ion current developed sharp blockades spikes, similar to the ones observed in α-HL experiments.

### Example 6

Sold-state nanopore arrays were fabricated by two approaches. One approach was to define a 2 micron characteristic cross-sectional dimension well array in a 750 nm thick Si₃N₄ and SiO₂ membrane with focused ion beam (FIB) and subsequently drill nanopores in each well with transmission electron microscope (TEM). The other approach was to directly create a nanopore array in a 50 nm thin Si₃N₄ membrane with automated scanning transmission electron microscope (STEM).

In the first approach, a two-layer structure, 200 nm of SiO₂ and 500 nm thick capping layer of Si₃N₄, was deposited by plasma enhanced chemical vapor deposition. A focused ion beam was employed to drill a 2 micrometer characteristic cross-sectional dimension well array in the first 500 nm thick silicon nitride layer. After this process, the silicon dioxide layer was removed by buffered oxide etch (BOE), to define a 50 nm thick silicon nitride membrane for single nanometer scale pores.

Arrays of low-density nanopores (2×2, 3×3, and 6×6) were integrated into a monolithic silicon-based chip using a scanning transmission electron microscope (STEM), in which technique the arrays were determined by patterning the beam scanning without well arrays. Automated patterning of nanopores was possible by running the microscope in STEM mode and directly addressing the scan coils to deflect the beam by the desired amount.

What is claimed:

1. A device, comprising:
a solid-state substrate comprising a first surface, a second surface, and at least 100 nanopores,
wherein each nanopore is functionalized with a charge-shielding agent.

2. The device of claim 1, wherein the solid-state substrate comprises one or more materials capable of being shaped or formed.

3. The device of claim 1, wherein the solid-state substrate comprises glass, quartz, silicon, alumina, tungsten, titanium, ceramic, alloys, metals, or any combination thereof.

4. The device of claim 1, wherein the solid state substrate comprises Si₃N₄, SiO₂, or any combination thereof.

5. The device of claim 1, wherein the area of the nanopore cavity is characterized as circular in cross section.

6. The device of claim 1, wherein the area of the nanopore cavity is characterized as being a polygon having from 2 to 12 sides.

7. The device of claim 1, wherein the charge shielding agent comprises one or more entities capable of reducing electrical interactions between the inner surface of the nanopores and any entity present within the nanopores, capable of reducing electrical noise present in one or more electrical connections comprising the nanopore, or any combination thereof.

8. The device of claim 1, wherein the charge-shielding agent comprises self-assembling organosilanes, proteinaceous agents, and bifunctional surfactants, or any combination thereof.

9. The device of claim 8, wherein organosilanes comprise glycidyloxypropyltrimethoxysilane, methoxyethoxy-undecyltrichlorosilane, aminopropyl-trimethoxysilane, 15-hexadecenyltrichlorosilane, octadecyltrichlorosilane, or any combination thereof.

10. (canceled)

11. The device of claim 8, wherein the bifunctional surfactants comprise one or more sulfates of a propoxylated, ethoxylated tridecyl alcohol.

12. The device of claim 1, wherein each nanopore has a characteristic cross-sectional dimension in the range of from about 0.5 nm to about 20 nm.

13. The device of claim 1, wherein each nanopore has a characteristic cross-sectional dimension in the range of from about 2 to about 15 nm.

14. The device of claim 1, wherein each nanopore has a characteristic cross-sectional dimension in the range of from about 5 to about 10 nm.

15. The device of claim 1, wherein the nanopores are separated by at least 5 micrometers from one another.

16. The device of claim 1, wherein the substrate comprises an area of at least 500 square micrometers.

17. A method, comprising:
(a) directing an electron beam of a scanning transmission electron microscope towards a target location on a first surface of a solid-state substrate;
(b) adjusting the electron beam so as to give rise to a cavity originating at the target location and extending at least partway into the solid state substrate, wherein the solid-state substrate comprises a first surface and a second surface, wherein the operating parameters of the electron beam comprise at least an intensity and an accelerating voltage;
(c) terminating the electron beam;
(d) inspecting the target location; and
(e) iteratively performing steps (a), (b), (c), and (d), so as to give rise to at least 100 template pores of desired characteristic cross-sectional dimension, wherein the template pores are capable of placing the first surface and second surface of the solid state substrate in fluid communication with one another.

18. The method of claim 17, wherein the electron beam comprises an intensity in the range of about 10⁷ e/nm²s to about 10¹¹ e/nm²s.

19. The method of claim 17, wherein the accelerating voltage of the electron beam is in the range of from about 150 keV to about 300 keV.

20. The method of claim 17, wherein the accelerating voltage of the electron beam is in the range of from about 200 keV to about 250 keV.

21 The method of claim 17, wherein inspecting the target location comprises optically inspecting the target location.

22. The method of claim 17, wherein inspecting the target location comprises inspecting the target location with an electron microscope.

23. The method of claim 17, wherein adjusting the operating parmeters comprises using an α-selector and spot size setting of 3 and 1, respectively, to improve electron beam coherence.

24. The method of claim 17, further comprising activating a wobbler so as to optimize the focus of the electron beam on the substrate surface, viewing a live fast Fourier transform of the substrate, or any combination thereof.

25. The method of claim 17, wherein inspecting the target location comprises measuring the transmission rate of electrons, ions, or any combination thereof, at the target location.

26. The method of claim 17, wherein the scanning transmission electron microscope comprises a condenser stigmator.

27. The method of claim 26, further comprising adjusting the condenser stigmator so as to give rise to an electron beam pattern on the solid state substrate capable of ablating material from the solid state substrate.

28. The method of claim 27, further comprising fully converging the condenser stigmator to cross-over then over-focusing the condenser stigmator to give rise to a locus of high intensity surrounded by a locus characterized as being in the form of a halo.

29. The method of claim 28, wherein the locus comprises a central point and a triangular halo, wherein the point and halo comprise intensities in the range of from about 10⁸-10⁹ e/nm²s and in the range of from about 10⁴-10⁵ e/nm²s, respectively.

30. The method of claim 17, wherein the template pore has a characteristic cross-sectional dimension in the range of from about 5 nm to about 10 nm.

31. The method of claim 17, further comprising forming one or more additional pores of desired characteristic cross-sectional dimension in the solid state substrate.

32. The method of claim 31, wherein forming additional pores comprises utilizing the operating parameters of the electron beam used to form the template pore.

33. The method of claim 32, wherein the operating parameters further comprise dwell time, electron energy loss spectra, or any combination thereof.

34. The method of claim 32, further comprising directing the electron beam of the scanning transmission electroscope to one or more additional locations on a surface of the solid state substrate, wherein the operating parameters of the electron beam directed to the one or more additional locations are those operating parameters used in forming the template pore.

35. The method of claim 31, further comprising the use of a scanning transmission electron microscope control system.

36. The method of claim 17, wherein the template pores are separated by at least 5 micrometers from one another.

37. The method of claim 17, wherein the substrate has a surface area of at least 500 square micrometers.

38. The method of claim 17, further comprising at least the steps of:
(g) directing an electron beam of a scanning transmission electron microscope at or proximate to a template pore;
(h) adjusting the operating parameters of the electron beam so as to give rise to an electron beam capable of sputtering solid state substrate material so as to reduce the characteristic cross-sectional dimension of the template pore, wherein the operating parameters comprise an intensity and an accelerating voltage;
(i) terminating the electron beam;
(j) inspecting the template pore;
(k) iteratively performing steps (g), (h), (i), and (j) so as to give rise to a final pore of desired characteristic cross-sectional dimension, wherein the pore places the first surface and second surface of the solid state substrate in fluid communication with one another.

39. The method of claim 38, wherein the electron beam comprises an intensity in the range of from about 10⁴ e/nm²s to about 10⁸ e/nm²s.

40. The method of claim 38, wherein the accelerating voltage of the electron beam is in the range of from about 150 keV to about 300 keV.

41. The method of claim 38, wherein inspecting the pore comprises optically inspecting the target location.

42. The method of claim 17, wherein inspecting the target location comprises inspecting the target location with an electron microscope.

43. The method of claim 38, comprising using an α-selector and spot size setting of 3 and 1, respectively, to improve electron beam coherence.

44. The method of claim 38, further comprising activating a wobbler so as to optimize the focus of the electron beam on the substrate surface, using a digital micrograph to view a live fast Fourier transform of the substrate, or any combination thereof.

45. The method of claim 38, wherein inspecting the pore comprises measuring the transmission rate of electrons, ions, or any combination thereof, at the target location.

46. The method of claim 38, wherein the final pore has a characteristic cross-sectional dimension in the range of from about 0.5 nm to about 20 nm.

47. The method of claim 38, further comprising forming one or more additional final pores from the template pores.

48. The method of claim 47, wherein forming additional pores comprises utilizing the operating parameters of the electron beam used to form a final pore.

49. The method of claim 48, wherein the operating parameters further comprise dwell time, electron energy loss spectra, or any combination thereof.

50. The method of claim 49, further comprising directing the electron beam of the scanning transmission electroscope proximate to one or more additional final pores on a surface of the solid state substrate, wherein the operating parameters of the electron beam are capable of forming the final pore.

51. The method of claim 47, further comprising the use of a scanning transmission electron microscope control system.

52. The method of claim 17, wherein the thickness of the solid-state substrate is in the range of from about 20 nm to about 400 nm.

53. The method of claim 17, wherein the thickness of the solid state substrate is in the range of from about 50 nm to about 200 nm.

54. The method of claim 17, wherein the thickness of the solid state substrate is in the range of from about 80 nm to about 100 nm.

55. The method of claim 17, wherein the solid-state substrate comprises glass, quartz, silicon, alumina, tungsten, titanium, ceramic, alloys, metals, or any combination thereof.

56. The method of claim 55, wherein the solid state substrate comprises Si₃N₄, SiO₂, or any combination thereof.

57. A device made according to the method of claim 17.

58. The device of claim 57, wherein the device is used as a sequencer, a probe, a sensor, a filter, or any combination thereof.

59. A method, comprising:
ablating material from a first surface of a solid-state substrate so as to give rise to plurality of cavities formed within the first surface, the cavity comprising a bottom contiguous with the first surface; and
forming at least 100 nanopores extending between the bottom surface of the cavities and a second surface of the substrate.

60. The method of claim 59, wherein the solid-state substrate comprises one or more layers.

61. The method of claim 60, wherein the layers reside parallel to one another.

62. The method of claim 61, wherein the substrate comprises a primary layer having a first surface and a second surface, wherein the primary layer has a thickness in the range of from about 5 nm to about 1000 nm.

63. The method of claim 59, wherein the primary layer comprises glass, quartz, silicon, alumina, tungsten, titanium, ceramic, alloys, metals, or any combination thereof.

64. The method of claim 59, wherein the primary layer comprises Si₃N₄.

65. The method of claim 59, wherein the substrate further comprises a secondary layer comprising a first and a second surface, and wherein the second surface of the primary layer surmounts the first surface of the secondary layer.

66. The method of claim 59, wherein the secondary layer has a thickness in the range of from about 20 nm to about 500 nm.

67. The method of claim 59, wherein the secondary layer comprises glass, quartz, silicon, alumina, tungsten, titanium, ceramic, alloys, metals, or any combination thereof

68. The method of claim 59, wherein the secondary layer comprises SiO₂.

69. The method of claim 59 wherein the substrate further comprises a tertiary layer comprising an first and a second surface, and wherein the second surface of the secondary layer surmounts the first surface of the tertiary layer.

70. The method of claim 59, wherein the tertiary layer has a thickness in the range of from about 20 nm to about 200 nm.

71. The method of claim 59, wherein the tertiary layer comprises glass, quartz, silicon, alumina, tungsten, titanium, ceramic, alloys, metals, or any combination thereof.

72. The method of claim 59, wherein the tertiary layer comprises Si₃N₄.

73. The method of claim 59, wherein the ablating is effectuated using ion beam drilling, exposure to electron beam, chemical etching, photolithography, microfabrication, pulling, or any combination thereof.

74. The method of claim 73, wherein the bottom surface of the cavities comprises at least a portion of the first surface of the secondary layer residing proximate to the primary layer.

75. The method of claim 74, further comprising ablating material from the secondary layer such that the bottom surface of the cavities comprises at least a portion of the first surface of the tertiary layer residing proximate to the secondary layer.

76. The method of claim 74, wherein the ablating comprises ion beam drilling, exposure to electron beam, chemical etching, photolithography, microfabrication, pulling, or any combination thereof.

77. The method of claim 74, wherein the cavities has a characteristic cross-sectional dimension in the range of from about 500 nm to about 5000 nm.

78. The method of claim 77, wherein the cavities have a cross-sectional area characterized as circular.

79. The method of claim 77, wherein the cavities have a cross-sectional area characterized as a polygon having from 2 to 12 sides.

80. The method of claim 59, wherein forming the at least 100 nanopores comprises removing material from the bottom surface of the cavity to give rise to apertures at the bottom surface of the cavities, wherein the apertures place the first and second surfaces of the solid-state substrate in fluid communication with each other.

81. The method of claim 80, wherein the material is removed from the bottom surface of the cavities using ion beam drilling, exposure to electron beam, chemical etching, photolithography, microfabrication, pulling, or any combination thereof.

82. The method of claim 81, wherein the apertures have a cross-sectional area characterized as circular.

83. The method of claim 81, wherein the apertures have a cross-sectional area characterized as a polygon having from 2 to 12 sides.

84. The method of claim 59, wherein the nanopores comprise lumens.

85. The method of claim 84, wherein the lumens comprise a length of about the thickness of the tertiary layer of the solid-state substrate.

86. The method of claim 84, wherein the apertures have a characteristic cross-sectional dimension in the range of from about 0.5 nm to about 20 nm.

87. The method of claim 84, wherein the apertures have a characteristic cross-sectional dimension in the range of from about 2 to about 10 nm.

88. The method of claim 84, wherein the apertures have a characteristic cross-sectional dimension in the range of from about 5 to about 8 nm.

89. The method of claim 59, wherein the nanopores are separated by at least 5 micrometers from one another.

90. The method of claim 59, wherein the substrate has a surface area of at least 500 square micrometers.

91. A device made according to claim 59.

92. The device of claim 91, wherein the device is used as probe, a sensor, a sequencer, a filter, or any combination thereof.

93. A method, comprising:
adapting at least 100 nanopore openings in a solid-state substrate such that the adapted openings are capable of conjugating a lipid entity; and
conjugating a lipid entity to the adapted nanopore openings.

94. The method of claim 93, wherein the solid-state substrate comprises glass, ceramic, alloys, metals, quartz, silicon, alumina, tungsten, titanium, or any combination thereof.

95. The method of claim 93, wherein adapting the nanopore openings comprises contacting the solid-state substrate with an agent capable of giving rise to a positive charge on the surface of the substrate.

96. The method of claim 93, comprising contacting the solid-state substrate with an amine-modified silane.

97. The method of claim 93, further comprising contacting the solid-state substrate with poly-D-lysine hydrobromide, poly-L-lysine hydrobromide, poly-L-lysine, poly-L-ornithine hydrobromide, or any combination thereof.

98. The method of claim 93, wherein the lipid entity comprises a unilamellar lipid vesicle, a giant unilamellar vesicle, a bilayer lipid vesicle, a lipid layer, a lipid bilayer, or any combination thereof.

99. The method of claim 93, wherein the conjugating comprises contacting the lipid entity to the adapted nanopore openings.

100. The method of claim 99, further comprising positioning the lipid entity relative to the nanopore using a directed electric field, prior to contacting the lipid entity to the adapted nanopore openings.

101. The method of claim 93, further comprising contacting a channel-forming agent to the conjugated lipid entity under conditions capable of giving rise to one ore more channels extending through the lipid entity.

102. The method of claim 101, wherein the channel-forming agent comprises alpha-hemolysin, B. anthracis protective antigen 63 (PA₆₃), or any combination thereof

103. The method of claim 93, wherein the at least 100 nanopores are separated by at least 5 micrometers from one another.

104. The method of claim 93, wherein the solid-state substrate has a surface area of at least 500 square micrometers.

105. A device made according to the method of claim 93.

106. The device of claim 105, wherein the device is used as a probe, a sensor, a sequencer, a filter, or any combination thereof.

107. A method, comprising:
modifying at least a portion of an inner surface of at least 100 solid-state nanopores; and
conjugating a charge-shielding agent to at least a portion of the modified portion of the inner surface of the solid-state nanopores.

108. The method of claim 107, wherein the modifying comprises contacting at least a portion of an inner surface of at least 100 solid-state nanopores with an agent.

109. The method of claim 108, wherein the agent is capable of giving rise to at least one anchoring group on the inner surface of the solid-state nanopores.

110. The method of claim 109, wherein the agent comprises piranha solution, RCA solution, or any combination thereof.

111 The method of claim 109, wherein the anchoring group is capable of conjugating to a charge-shielding agent.

112. The method of claim 111, wherein the anchoring group comprises silicon, silicon nitride, silanol, or any combination thereof.

113. The method of claim 107, wherein conjugating a charge shielding agent comprises contacting the charge-shielding agent to the modified inner surface of the at least 100 nanopores.

114. The method of claim 107, wherein the charge-shielding agent comprises one or more entities capable of reducing electrical interactions between the inner surface of the nanopores and any entity present within the nanopores, capable of reducing electrical noise present in one or more electrical connections comprising the nanopores, or any combination thereof.

115. The method of claim 107, wherein the charge-shielding agent further comprises entities having tunable end groups.

116. The method of claim 107, wherein the charge-shielding agent comprises organosilanes, bifunctional surfactants, or any combination thereof.

117. The device of claim 116, wherein organosilanes comprise glycidyloxypropyltrimethoxysilane, methoxyethoxy-undecyltrichlorosilane, aminopropyl-trimethoxysilane, 15-hexadecenyltrichlorosilane, octadecyltrichlorosilane, or any combination thereof.

118. The device of claim 116, wherein the bifunctional surfactants comprise one or more sulfates of a propoxylated, ethoxylated tridecyl alcohol.

119. The method of claim 107, wherein the at least 100 nanopores are separated by at least 5 micrometers from one another.

120. A device made according to claim 107.

121. The device of claim 120, wherein the device is used as a sensor, a probe, a filter, or any combination thereof.

122. A method, comprising:
inducing linear passage of at least a portion of a molecule through at least a portion of 100 or more nanopores, wherein each nanopore comprises at least one inner surface, wherein each nanopore has a characteristic cross-sectional dimension in the range of from about 0.5 nm to about 50 nm, and wherein a charge-shielding agent is present on at least a portion of at least one inner surface of the nanopore;
detecting one or more signals arising from the passage of the molecule through the one or more nanopores; and
analyzing the one or more signals.

123. The method of claim 120, wherein the one or more nanopores are formed in a solid state substrate.

124. The method of claim 120, wherein the solid state substrate comprises glass, quartz, silicon, alumina, tungsten, titanium, ceramic, alloys, metals, or any combination thereof.

125. The method of claim 122, wherein the charge-shielding agent comprises an entity capable of reducing electrical interactions between the inner surface of the nanopores and any entity present within the nanopores, capable of enhancing the signal-to-noise ratio of one or more electrical connections made to the nanopore, or any combination thereof.

126. The method of claim 122, wherein the charge-shielding agent comprises entities capable of conjugating to the inner surface of the nanopore.

127. The method of claim 122, wherein the charge-shielding agent comprises organosilanes, bifunctional surfactants, or any combination thereof.

128. The method of claim 127, wherein organosilanes comprise glycidyloxypropyltrimethoxysilane, methoxyethoxy-undecyltrichlorosilane, aminopropyl-trimethoxysilane, 15-hexadecenyltrichlorosilane, octadecyltrichlorosilane, or any combination thereof.

129. The method of claim 127, wherein the bifunctional surfactants comprise one or more sulfates of a propoxylated, ethoxylated tridecyl alcohol.

130. The device of claim 122, wherein the charge-shielding agent comprises alpha-hemolysin, B. anthracis protective antigen 63 (PA₆₃), or any combination thereof

131. The method of claim 122, wherein inducing linear passage of at least a portion of a polymer through at least a portion of one or more nanopores comprises translocating at least a portion of the polymer through at least a portion of at least one nanopore mechanically, chemically, electrochemically, electrically, optoelectronically, magnetically, osmotically, acoustically, or any combination thereof.

132. The method of claim 122, wherein the signal comprises an electrical signal, an optical signal, a mechanical signal, a radioactive signal, a magnetic signal, an acoustic signal, or any combination thereof.

133. The method of claim 122, wherein analyzing the signal comprises recording the signal, comparing the signal to a signal known to correspond to the passage through the nanopore of a monomer, comparing the signal to other recorded or real time signals, transmitting the signal, performing mathematical operations on the signal, or any combination thereof.

134. In a device having a solid-state substrate, the solid-state substrate having a first surface, a second surface, and at least one nanopore, the nanopore having a first aperture in the first surface of the substrate, a second aperture in the second surface of the substrate, and a cavity in the solid state substrate, the cavity placing the first aperture of the nanopore in fluid communication with the second aperture of the nanopore, wherein the improvement comprises:
the solid-state substrate comprising at least 100 nanopores,
wherein each nanopore is functionalized with a charge-shielding agent.
